(19) United States
(12) Patent Application Publication
(10) Pub. No.: US 2010/0112143 A1
(43) Pub. Date: May 6, 2010

(54) Animal Food and Packaging Therefor

(76) Inventor: NeKae Liberatore, Mount Holly, NC (US)

Correspondence Address: HARSHAW RESEARCH, INC., 210 W. TECUMSEH STREET, OTTAWA, KS, 66067, US

(21) Appl. No.: 12/263,563

(22) Filed: Nov. 3, 2008

(51) Int. Cl. A23K 1/00

(52) U.S. Cl. 426/106

(57) ABSTRACT

An animal food product and packaging includes gelatin combined with a broth base and subsequently coagulated to form a nutritious and digestible food product that is ingestible without chewing. The invention includes a package having an interior area and a resealable flap providing selective access to the interior area, the food product being coagulated and stored in the interior area. The broth includes at least one of beef broth, chicken broth, pork broth, or vegetable broth. The food product may include at least one of a medication or a nutritional supplement combined with the broth base before the food product is coagulated.

### BACKGROUND OF THE INVENTION

This invention relates generally to animal foods and, more particularly, to animal food for nourishing and hydrating animals having damaged teeth, no teeth, or recovering from medical procedures. Further, this invention relates to packaging for storing and dispensing the animal food products.

Similar to humans, a pet may not be able to eat normally following surgery, especially in the case of oral surgery or if suffering from other mouth ailments. In addition, an animal may need a more gentle source of nutrition and hydration than would be provided through a normal diet.

Various animal foods have been proposed in the art for providing nourishment to animals. Although assumably effective for their intended purposes, the existing products do not provide an animal food that combines an easy to eat gelatin with a nutritious broth base ingestible without chewing. Further, the existing products do not include packaging that is resealable and provides selective access to an interior storage area where the food product is stored.

Therefore, it would be desirable to have a food product and packaging that eliminates the disadvantages of the prior products and proposals, but rather provides a nutritious food product that is selectively accessible in a resealable package.

### SUMMARY OF THE INVENTION

An animal food product and packaging according to the present invention includes gelatin combined with a broth base and subsequently coagulated to form a nutritious and digestible food product that is ingestible without chewing. The invention includes a package having an interior area and a resealable flap providing selective access to the interior area, the food product being coagulated and stored in the interior area. The broth includes at least one of beef broth, chicken broth, pork broth, or vegetable broth. The food product may include at least one of a medication or a nutritional supplement combined with the broth base before the food product is coagulated.

Therefore, a general object of this invention is to provide an animal food product and packaging that provides hydration and nutritional nourishment to pets that have had surgery or that have diseased or a lack of teeth.

Another object of this invention is to provide an animal food product and packaging, as aforesaid, that provides nourishment without chewing.

Still another object of this invention is to provide an animal food product and packaging, as aforesaid, in which the packaging is resealable for selective and repeated access to the food product.

Yet another object of this invention is to provide an animal food product and packaging, as aforesaid, that is cost effective and easy to use.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an animal food and packaging device according to a preferred embodiment of the present invention with a lid in a closed configuration; and

FIG. 2 is a perspective view of the animal food and packaging as in FIG. 1 with a lid in an open configuration.

### DESCRIPTION OF THE PREFERRED EMBODIMENT

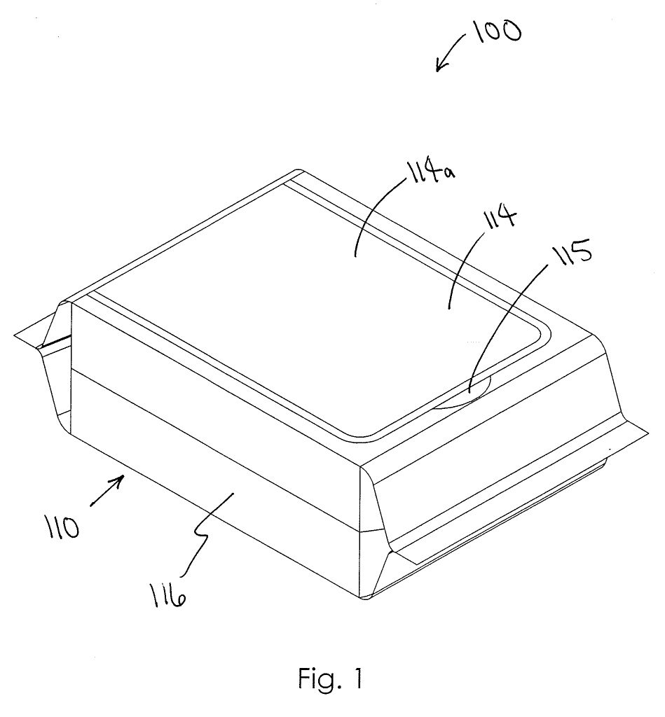

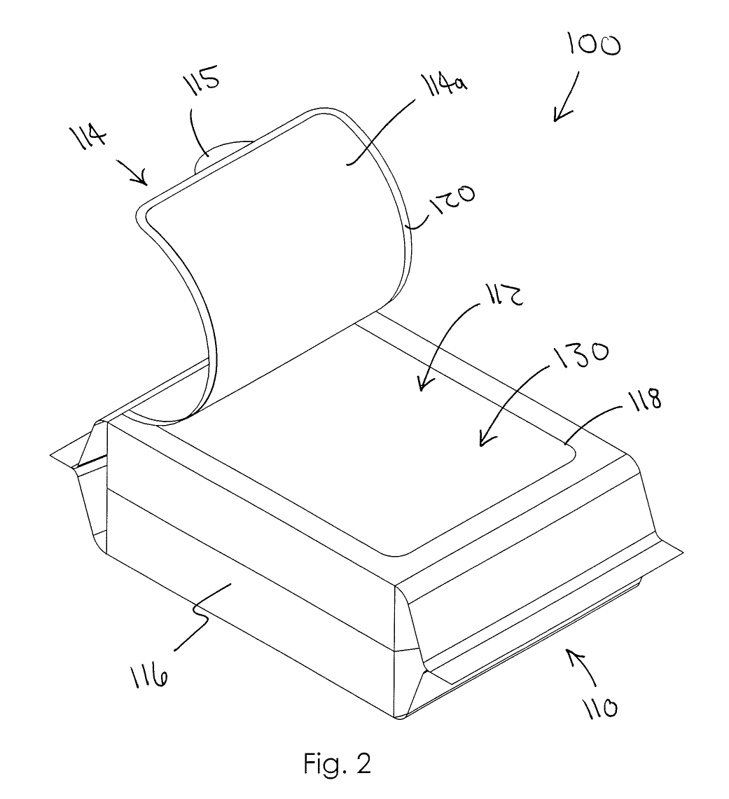

Animal food and packaging therefor 100 will now be described in detail with reference to FIG. 1 and FIG. 2 of the accompanying drawings. As shown in FIGS. 1 and 2, a package 110 has an interior area 112 and a flap 114a or other lid 114 providing selective access to the interior area 112. A container portion 116 defines the interior area 112, and removal of the flap 114a (FIG. 2) exposes an opening 118 to the interior area 112. The opening 118 may be sized to allow a dog snout or the mouth of another selected animal to enter the interior area 112. The container portion 116 may be constructed from aluminum, tin, paper, plastic, or any other appropriate material.

In some embodiments, the lid 114 is resealable to the container portion 116. For example, the flap 114a and/or the container portion 116 may have a resealable adhesive 120 (FIG. 2) to selectively reseal the interior area 112 with the flap 114a . The lid 114 may include a tab 115 that does not include or interact with the resealable adhesive 120 to allow the lid 114 to be easily accessed.

Gelatin (e.g., “plain” or “unflavored” gelatin) is combined with a broth base and subsequently coagulated to form a nutritious and digestible food product 130 that is ingestible without chewing. The food product 130 is coagulated and stored in the interior area 112, as shown in FIG. 2. The container portion 116 in contact with the food product 130 may be constructed from or coated with a food grade packaging material (e.g., a food grade wax) to preserve the integrity of the food product 130, and the food product 130 may finish coagulating in the interior area 112 before or after the lid 114 seals the interior area 112. Environmental factors such as temperature may be altered to facilitate the coagulation process, and it may be desirable to heat the broth base before combining with the gelatin.

The broth base may include beef broth, chicken broth, pork broth, vegetable broth, and/or any other appropriate broth, and various herbs and spices may be combined with the gelatin and the broth base before coagulation. In addition, the food product 130 may include at least one medication or nutritional supplement. In some embodiments, the medication(s) and/or supplement(s) are combined with the broth base before the food product 130 is coagulated (i.e., before coagulation is finished). In other embodiments, the medication(s) and/or supplement(s) are combined with the food product 130 after coagulation.

In use, the animal food and packaging 100 is purchased or otherwise obtained. To feed a dog or other animal, the lid 114 may be removed (e.g., by gripping the tab 115) to expose the opening 118. The food product 130 may then be removed from the interior area 112 and given to the animal, or the animal may be allowed to consume the food product 130 directly from the interior area 112. To store any unused portion of the food product 130, the lid 114 may be resealed to the container portion 116 by the resealable adhesive 120, and the package 110 may be refrigerated if desired.

Due to the texture and contents of the food product 130, the food product 130 may be easily ingested by animals having no teeth or other dental problems and may also be easily digested. The food product 130 may be a convenient medium for delivering medication and/or nutritional supplements, as the animal may unknowingly consume the medication and/or nutritional supplements when ingesting the food product 130.

It is understood that while certain forms of this invention have been illustrated and described, it is not limited thereto except insofar as such limitations are included in the following claims and allowable functional equivalents thereof.

1. Animal food and packaging therefor, comprising:
gelatin combined with a broth base and subsequently coagulated to form a nutritious and digestible food product that is ingestible without chewing; and
a package having an interior area and a resealable flap providing selective access to said interior area, said food product being coagulated and stored in said interior area.

2. The animal food and packaging of claim 1, wherein said broth base includes at least one of: beef broth, chicken broth, pork broth, or vegetable broth.

3. The animal food and packaging of claim 2, further comprising at least one herb or spice combined with said gelatin and said broth base before said coagulation.

4. The animal food and packaging of claim 3, further comprising at least one of a medication or a nutritional supplement combined with said broth base before said food product is coagulated.

5. The animal food and packaging of claim 4, wherein:
said package has a container portion defining said interior area;
at least one of said resealable flap and said container portion has resealable adhesive to selectively reseal said interior area with said resealable flap; and
said resealable flap includes a tab that does not include or interact with said resealable adhesive.

6. The animal food and packaging of claim 5, wherein said container portion in contact with said food product is constructed from or coated with a food grade packaging material.

7. The animal food and packaging of claim 1, further comprising at least one of a medication or a nutritional supplement combined with said broth base before said food product is coagulated.

8. Animal food and packaging therefor, comprising:
gelatin combined with a broth base and subsequently coagulated, whereby forming a nutritious and digestible food product that is ingestible without chewing; and
a package having an interior area and a flap providing selective access to said interior area, said gelatin and broth base combination being placed in said interior area before said coagulation is finished.

9. The animal food and packaging of claim 8, wherein said broth base includes at least one of: beef broth, chicken broth, pork broth, or vegetable broth.

10. The animal food and packaging of claim 8, further comprising at least one of a medication or a nutritional supplement in said food product.

11. The animal food and packaging of claim 8, wherein:
said package has a container portion defining said interior area; and
said container portion in contact with said food product is constructed from or coated with a food grade packaging material.

12. The animal food and packaging of claim 11, wherein removal of said flap exposes an opening to said interior area sized to allow a dog snout to enter said interior area.

13. The animal food and packaging of claim 12, wherein:
at least one of said flap and said container portion has resealable adhesive to selectively reseal said interior area with said flap; and
said flap includes a tab that does not include or interact with said resealable adhesive.

14. Animal food and packaging therefor, comprising:
gelatin combined with a broth base and subsequently coagulated, whereby forming a nutritious and digestible food product that is ingestible without chewing; and
a package having an interior area and a lid restricting access to said interior area, said gelatin and broth base combination being placed in said interior area before said coagulation is finished.

15. The animal food and packaging of claim 14, wherein removal of said lid exposes an opening to said interior area sized to allow a dog snout to enter said interior area.

16. The animal food and packaging of claim 15, wherein said broth base includes at least one of: beef broth, chicken broth, pork broth, or vegetable broth.

17. The animal food and packaging of claim 16, further comprising at least one herb or spice combined with said gelatin and said broth base before said coagulation.

18. The animal food and packaging of claim 17, wherein:
said package has a container portion defining said interior area; and
at least one of said lid and said container portion has resealable adhesive to selectively reseal said interior area with said lid.

19. The animal food and packaging of claim 18, wherein said lid includes a tab that does not include or interact with said resealable adhesive.

20. The animal food and packaging of claim 19, further comprising at least one of a medication or a nutritional supplement combined with said broth base before said coagulation is finished
